(19) United States
(12) Patent Application Publication
(10) Pub. No.: US 2015/0126218 A1
(43) Pub. Date: May 7, 2015

(54) SYSTEM AND METHOD FOR DETERMINING POSITIONS OF APPARATUSES WIRELESSLY COUPLED WITHIN A CASE

(71) Applicant: FUJITSU LIMITED, Kawasaki-shi (JP)

(72) Inventor: Tatsuhiko NEGISHI, Yokohama (JP)

(73) Assignee: FUJITSU LIMITED, Kawasaki-shi (JP)

(21) Appl. No.: 14/513,624

(22) Filed: Oct. 14, 2014

(30) Foreign Application Priority Data
Nov. 6, 2013 (JP) 2013-230590

(51) Int. Cl. H04W 4/02

(52) U.S. Cl. CPC H04W 4/02
USPC 455/456.1

(57) ABSTRACT

A system includes a plurality of information processing apparatuses, a case including a plurality of stages each configured to accommodate information processing apparatuses in a row, and a controller. The controller specifies, for each of the plurality of information processing apparatuses, a first fixed antenna among fixed antennas fixed to predetermined positions within the case or adjacent information processing apparatuses adjacent to the each information processing apparatus by causing the each information processing apparatus to conduct a wireless communication using the fixed antennas or antennas provided for the adjacent information processing apparatuses. The controller estimates a position of the each information processing apparatus within the case, based on the specified adjacent information apparatuses or the specified first fixed antenna.

### CROSS-REFERENCE TO RELATED APPLICATION

This application is based upon and claims the benefit of priority from the prior Japanese Patent Application No. 2013-230590 filed on Nov. 6, 2013, the entire contents of which are incorporated herein by reference.

### FIELD

The embodiments discussed herein are related to a system and method for determining positions of apparatuses wirelessly coupled within a case.

### BACKGROUND

There is an information processing system having a case which accommodates a number of nodes and a network switch for communication with an external network. As used herein, the term “node” refers to an information processing apparatus including a CPU, a memory controller, a memory, a storage controller, a storage, a wireless LAN (Local Area Network) controller, a baseband and RF (Radio Frequency) unit, and an interconnect.

Each node conducts wireless communication with other nodes using the wireless LAN. To this end, each node has a routing table associating a destination node of a frame to be transmitted in the wireless communication with a next node as a next transmission node.

FIG. 13 is a diagram illustrating an example of a frame routing using a routing table. FIG. 13 illustrates a case where a node A transmits a frame to a node O. Each node may conduct wireless communication with adjacent nodes: lower, left, right, left-upper, right-upper, left-lower, and right-lower nodes.

As illustrated in FIG. 13, a routing table of the node A stores information on a next node F in association with information on a destination node O. Accordingly, the node A transmits a frame destined for the destination node O to the node F. A routing table of the node F stores information on a next node K in association with information on the destination node O. Accordingly, the node F transmits the frame destined for the destination node O to the node K. A routing table of the node K stores information on a next node O in association with information on the destination node O. Accordingly, the node K transmits the frame to the destination node O.

In order to prepare a routing table, it is necessary to specify a position of each node within the case. If an incorrect routing destination is registered in the routing table without correctly specifying the position of each node within the case, it is impossible to conduct communication between nodes.

In addition, as one of techniques for specifying a position of an apparatus, there has been conventionally proposed a technique in which an infrared ray communication device is mounted on each of a hub, a PC, and a printer, which constitute a LAN, to emit in all directions an infrared ray having high directionality so as to specify the arrangement of each of the hub, the PC, and the printer (see, e.g., Japanese Laid-Open Patent Publication No. 2001-209597A). In addition, there has been conventionally proposed an in-case communication technique for establishing a wireless communication between devices inside a case without using a backplane board in a blade server in which, for example, a server module, a switch module, and a management module are accommodated in one case (see, e.g., Japanese Laid-Open Patent Publication No. 2005-184659A).

### SUMMARY

According to an aspect of the invention, a system includes a plurality of information processing apparatuses, a case including a plurality of stages each configured to accommodate information processing apparatuses in a row, and a controller. The controller specifies, for each of the plurality of information processing apparatuses, a first fixed antenna among fixed antennas fixed to predetermined positions within the case or adjacent information processing apparatuses adjacent to the each information processing apparatus by causing the each information processing apparatus to conduct a wireless communication using the fixed antennas or antennas provided for the adjacent information processing apparatuses. The controller estimates a position of the each information processing apparatus within the case, based on the specified adjacent information apparatuses or the specified first fixed antenna.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a front view of an information processing system, according to an embodiment;

FIG. 2 is a diagram illustrating an example of a side view of an information processing system, according to an embodiment;

FIG. 3 is a diagram illustrating an example of a configuration of a node, according to an embodiment;

FIG. 4 is a diagram illustrating an example of a functional configuration of an overall controller, according to an embodiment;

FIG. 5 is a diagram illustrating an example of an adjacent node list, according an embodiment;

FIG. 6 is a diagram illustrating an example of an order for specifying a position of each node in a case, according to an embodiment;

FIG. 7 is a diagram a illustrating an example of a node map, according to an embodiment;

FIG. 8 is a diagram illustrating an example of a routing table, according to an embodiment;

FIG. 9 is a diagram illustrating an example of an operational flowchart for preparing a routing table, according to an embodiment;

FIG. 10 is a diagram illustrating an example of an operational flowchart for preparing a node map, according to an embodiment;

FIG. 11 is a diagram illustrating an example of a specified node list, according to an embodiment;

FIG. 12 is a diagram illustrating an example of a hardware configuration of an overall controller, according to an embodiment; and

FIG. 13 is a diagram illustrating an example of a frame routing using a routing table.

### DESCRIPTION OF EMBODIMENTS

It may be considered to specify a position of each node using a radio wave arrival time difference or a radio wave reception strength observed by each node when the node receives a long-range wireless signal. In a case where a node is located at a distance of several hundred meters to several kilometers, it is possible to estimate the position of the node using the radio wave arrival time difference scheme or the radio wave reception strength scheme.

However, in a case where hundreds of nodes are arranged within a case having a height of 2 meters or less and a width of 1 meter or less, an inter-node distance is too short to estimate the position of each node using the radio wave arrival time difference scheme or the radio wave reception strength scheme.

Hereinafter, embodiments of an information processing system, a positioning method and a positioning program disclosed in the specification will be described in detail with reference to the drawings. These embodiments do not limit techniques disclosed herein.

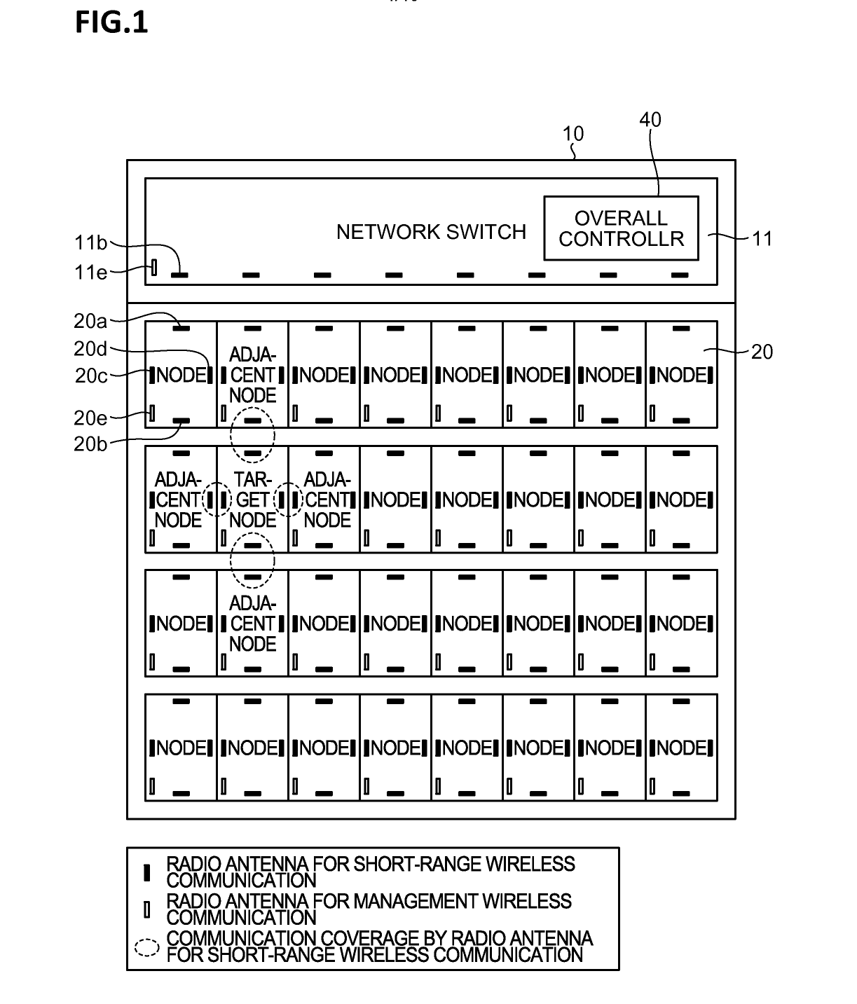

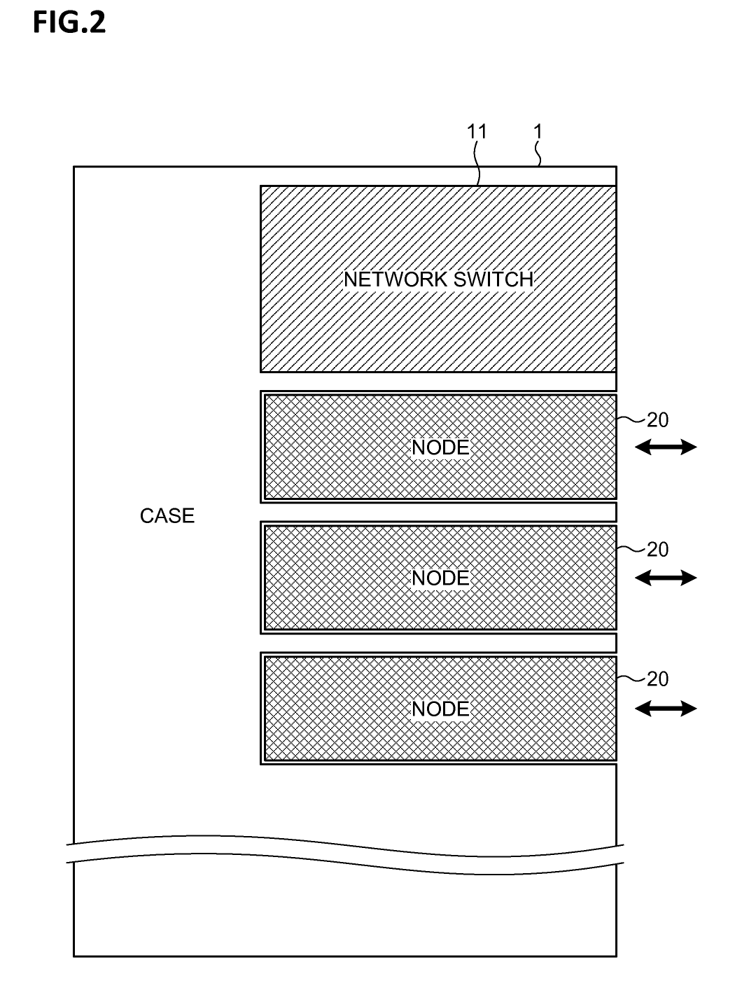

An information processing system according to an embodiment will be first described with reference to FIG. 1 and FIG. 2. FIG. 1 is a diagram illustrating an example of a front view of an information processing system, according to an embodiment, and FIG. 2 is a diagram illustrating an example of a side view of an information processing system, according to an embodiment.

As illustrated in FIG. 1, an information processing system 10 includes a network switch 11, and 32 nodes 20. Although the 32 nodes 20 are here illustrated for convenience of description, the information processing system 10 may include any number of nodes 20. As illustrated in FIG. 2, the network switch 11 and the nodes 20 are accommodated in slots of a case 1 and the node 20 may be detached from the slot of the case 1. The slots for accommodating a plurality of nodes 20 are arranged in a plurality of stages each configured to accommodate nodes 20 in a row as illustrated in FIG. 1.

The network switch 11 is used for the nodes 20 to communicate with an external network. The network switch 11 wirelessly communicates with the nodes 20 and includes a radio antenna 11b for short-range wireless communication and a radio antenna 11e for management wireless communication.

The radio antenna 11b for short-range wireless communication is an antenna for radio (hereinafter referred to as “short-range radio”) which is used for communication of the network switch 11 with an operating system (OS) or an application operated by the node 20 arranged in the uppermost stage of the case 1. In this example, the network switch 11 includes 8 (eight) radio antennas 11b for short-range wireless communication corresponding respectively to 8 nodes 20 arranged in the uppermost stage of the case 1.

The radio antenna 11e for management wireless communication is an antenna for radio (hereinafter referred to as “management radio”) which is used for, for example, the management of the nodes 20. Although the management radio is slower than the short-range radio, the management radio facilitates a long-distance communication as well as an inter-farthest node communication between farthest nodes or between the network switch 11 and the node.

The network switch 11 includes an overall controller 40 for controlling the nodes 20 and the network switch 11. The overall controller 40 allocates each node 20 with a node number which is an identifier for identifying each node 20 uniquely. The node number is generated by the overall controller 40 from a MAC (Media Access Control) address of the node 20. The overall controller 40 includes an MPU (Micro Processing Unit) and is implemented by executing firmware with the MPU.

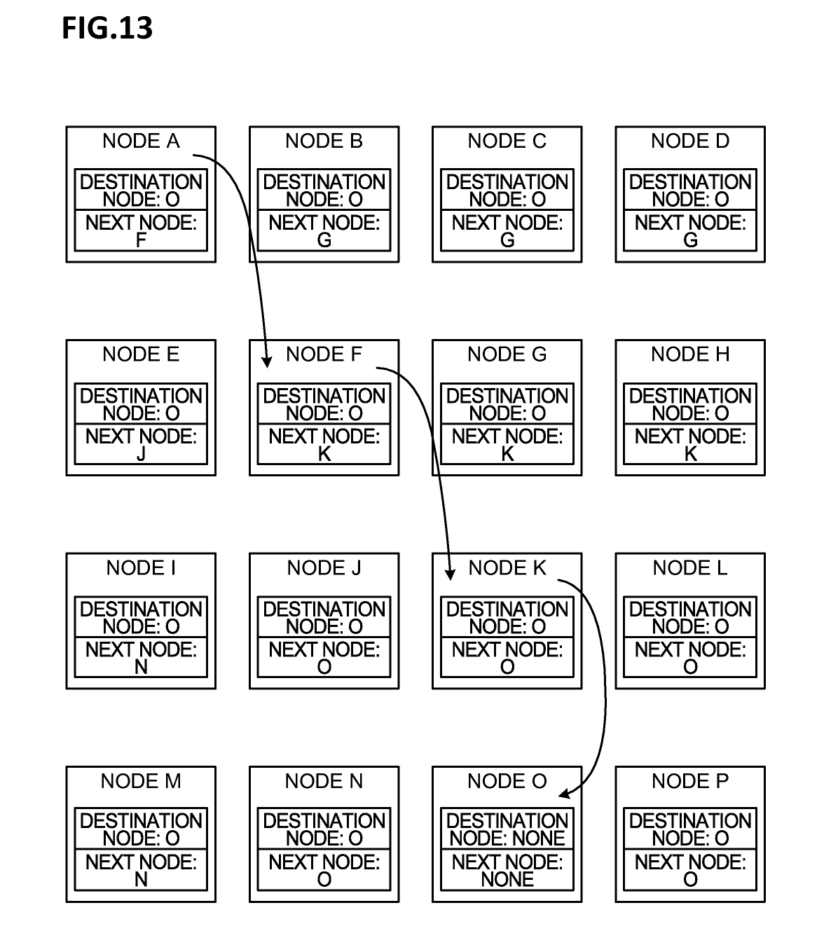

As opposed to that illustrated in FIG. 13, each node 20 includes a radio antenna 20a for short-range wireless communication with only an upper adjacent node 20, and a radio antenna 20b for short-range wireless communication with only a lower adjacent node 20. Each node 20 further includes a radio antenna 20c for short-range wireless communication with only a left adjacent node 20, and a radio antenna 20d for short-range wireless communication with only a right adjacent node 20. That is, as illustrated in FIG. 1, a target node 20 is configured to communicate with only the upper, lower, left and right adjacent nodes 20 in the short-range radio.

In addition, the node 20 arranged in the uppermost stage of the case 1 uses the radio antenna 20a for short-range wireless communication to conduct short-range wireless communication with the network switch 11 instead of the upper adjacent node 20. In addition, each node 20 includes a radio antenna 20e for management wireless communication used for a management radio.

There are no wired connector and wired signal line for connection between the node groups and the case 1 accommodating the groups. Each node 20 is supplied with power from the case 1 by wireless power feeding.

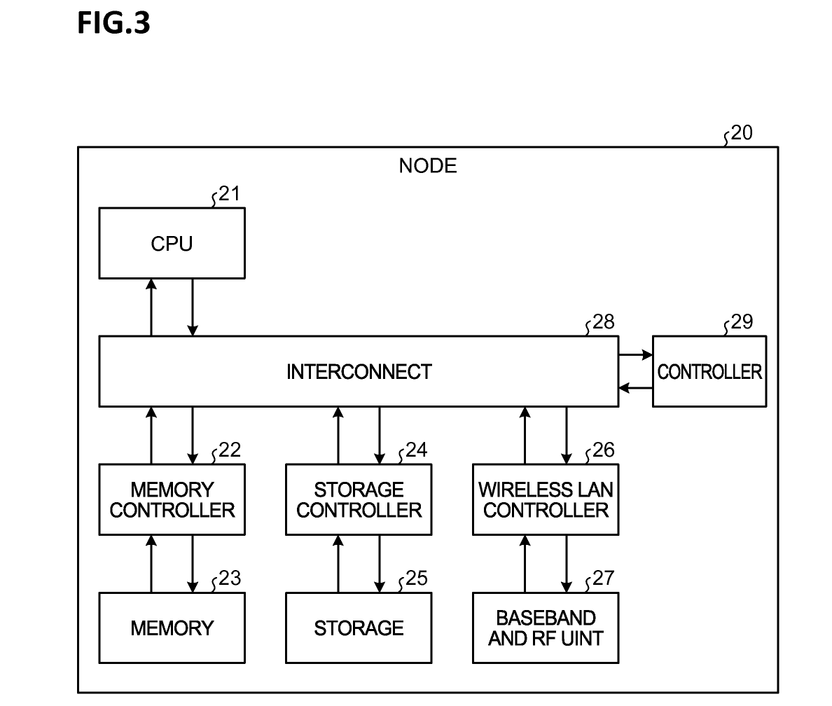

Next, a configuration of a node 20 will be described. FIG. 3 is a diagram illustrating an example of a configuration of a node, according to an embodiment. As illustrated in FIG. 3, a node 20 includes a CPU 21, a memory controller 22, a memory 23, a storage controller 24, a storage 25, a wireless LAN controller 26, a baseband and RF unit 27, and an interconnect 28. The node 20 further includes a controller 29.

The CPU 21 is a central processing unit for reading and executing a program stored in the memory 23. The memory controller 22 is a controller for controlling the writing of data into the memory 23 and reading of programs and data from the memory 23. The memory 23 is a RAM (Random Access Memory) storing programs and data.

The storage controller 24 is a controller for controlling the writing of data into the storage 25 and reading of programs and data from the storage 25. The storage 25 is a magnetic disk device storing programs and data.

The wireless LAN controller 26 is a controller for controlling the communication conducted by the wireless LAN used for the short-range radio and the management radio. For the short-range wireless communication, the wireless LAN controller 26 controls a determination which one of the radio antennas 20a to 20d is to be used for short-range wireless communication.

The baseband and RF unit 27 conducts wireless communication under the control of the wireless LAN controller 26. The interconnect 28 is a device that interconnects the CPU 21, the memory controller 22, the storage controller 24, the wireless LAN controller 26, and the controller 29 with one another.

802.11 ac/n may be used as a short-range wireless communication protocol and impulse radio may be used as physical baseband and RF. The impulse radio uses a millimeter wave which may make use the frequency in wideband, particularly in a 70 to 80 GHz band (E-band) which is less susceptible to atmospheric attenuation characteristics. In addition, the impulse radio has a strong linearity because of its high frequency and is invulnerable from the interference by other systems, allowing mass transmission (transmission capacity of 3.6 GHz) in both of uplink and downlink using a duplex system (71 GHz to 76 GHz and 81 GHz to 86 GHz).

Zigbee®, a wireless communication standard having a frequency band in 2.4 GHz, may be used as a management wireless communication scheme. Zigbee®, although implemented with a low speed (20 kbps to 250 kbps), is known as consuming less power with low cost and covering the communication of the entire area inside the case.

Here, it is assumed that 802.11 ac/n is used as a short-range wireless communication protocol, the impulse radio is used as physical baseband and RF, and Zigbee® is used as a communication scheme for the management radio. However, other communication protocols and communication schemes may be used as the short-range wireless communication protocol, physical baseband and RF, and the communication scheme for the management radio.

The controller 29 uses the management radio to control the nodes 20. The controller 29 includes an MPU and is implemented by executing firmware with the MPU. The controller 29 also includes a routing table associating an MAC address of a destination node with an MAC address of a next node, and routes a frame transmitted by a node 20 to another node 20.

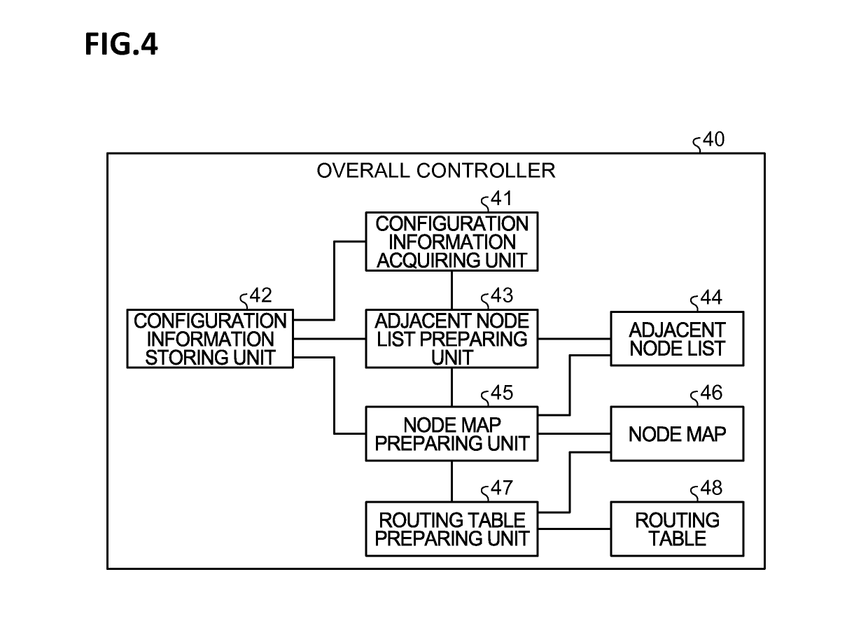

Next, the configuration of the overall controller 40 will be described. FIG. 4 is a diagram illustrating an example of a functional configuration of an overall controller, according to an embodiment. As illustrated in FIG. 4, an overall controller 40 includes a configuration information acquiring unit 41, a configuration information storing unit 42, an adjacent node list preparing unit 43, and an adjacent node list 44. The overall controller 40 further includes a node map preparing unit 45, a node map 46, a routing table preparing unit 47, and a routing table 48.

The configuration information acquiring unit 41 acquires configuration information of the network switch 11 and all the nodes 20 for the management radio. The configuration information storing unit 42 stores the configuration information acquired by the configuration information acquiring unit 41, for the network switch 11 and all the nodes 20. As used herein, the term “configuration information” refers to information on, for example, a CPU, memory, IO, and an MAC address.

More specifically, the configuration information acquiring unit 41 transmits a beacon to each node 20 via the management radio. Each node 20 which has received the beacon transmits a probe request via the management radio. The configuration information acquiring unit 41 transmits a probe response to the node which has transmitted the probe request via the management radio. Then, the configuration information acquiring unit 41 acquires the configuration information.

As used herein, the term “beacon” refers to a signal broadcasted by a device constituting a wireless network at regular time intervals in order for a newly arranged wireless communication device to detect, identify, and join the wireless network. As used herein, the term “probe request” refers to a signal transmitted by the newly arranged radio communication device to detect the wireless network, and the term “probe response” refers to a response to the probe request, transmitted by a device constituting the wireless network.

The adjacent node list preparing unit 43 selects a target node 20 from among all the nodes 20 in the order, and instructs the target node 20 to specify an adjacent node 20. Then, the adjacent node list preparing unit 43 acquires information of the adjacent node 20 from the target node 20 and prepares the adjacent node list 44.

The target node 20 broadcasts a probe request using the short-range radio. At this time, first, the target node 20 uses the radio antenna 20a for short-range wireless communication, to control the output and direction of the short-range radio such that a radio wave of the short-range radio arrives at only an upper adjacent node 20. Then, the target node 20 waits for a probe response from the upper nodes 20. Upon receiving the probe response, the target node 20 assumes a node 20 which has transmitted the probe response as the upper adjacent node 20.

Then, the target node 20 uses the radio antennas 20b to 20d for short-range wireless communication in this order to perform the same processing in the lower, left and right directions and specify the lower, left and right adjacent nodes 20. Then, the target node informs the adjacent node list preparing unit 42 of the upper, lower, left and right adjacent nodes 20.

Although it has been illustrated here that the target node 20 uses the probe request, the target node 20 may use a measurement request as an alternative to the probe request. In a case where the measurement request is used, the target node 20 receives a signal strength measurement result as an alternative to the probe response.

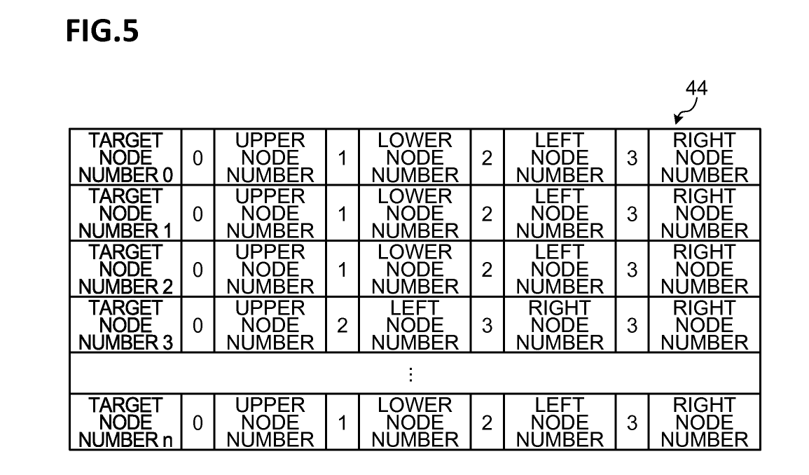

The adjacent node list 44 is a list storing information of adjacent nodes for each node 20. FIG. 5 is a diagram illustrating an example of an adjacent node list, according an embodiment. As illustrated in FIG. 5, the adjacent node list 44 stores a target node number, an upper node number, a lower node number, a left node number, and a right node number in association with each target node 20.

In FIG. 5, “0”, “1”, “2”, and “3” indicate that their subsequent values are the upper node number, the lower node number, the left node number, and the right node number, respectively. As used herein, the term “node number” refers to a number generated from a MAC address of a node 20.

For the nodes arranged in the uppermost stage of the case 1, the upper node number is the number identifying the radio antenna 11b for short-range wireless communication of the network switch 11. FIG. 5 shows adjacent nodes 20 for n+1 nodes 20 by numbering the target node number as “target node number 0” to “target node number n”.

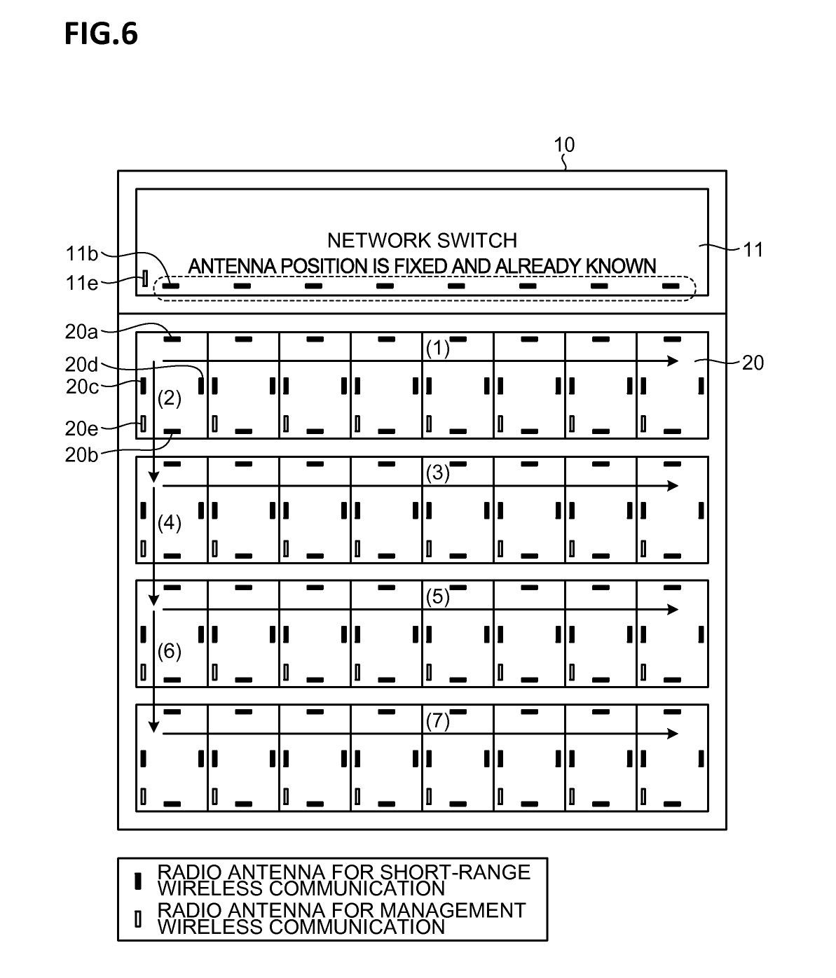

The node map preparing unit 45 analyzes the adjacent node list 44 to specify the position of each node 20 in the case 1, and prepare the node map 46. FIG. 6 is a diagram illustrating an example of an order for specifying a position of each node 20 in the case 1, according to an embodiment.

In FIG. 6, it is assumed that the position of the uppermost and leftmost node 20 is the origin, and a horizontal row and a vertical column of nodes 20 are respectively a row and a node column. The node map preparing unit 45 estimates the positions of nodes 20 in a node row of the uppermost stage sequentially in the horizontal direction from the node 20 at the origin, and when the position of the rightmost node 20 of the uppermost stage is estimated, the node map preparing unit 45 next estimates the positions of nodes 20 in a node row of the second stage, which is at one stage below the uppermost stage, from the left side in the horizontal direction.

For the uppermost nodes 20, since the position of each antenna of the network switch 11 is known, the node map preparing unit 45 specifies each node 20 that has a number identifying each radio antenna 11b for short-range wireless communication as the upper node number, as a node 20 of the uppermost stage (an uppermost node 20). Then, the node map preparing unit 45 specifies each node 20 having a number identifying each uppermost node 20 as the upper node number, as a node 20 of the next stage. In this manner, the node map preparing unit 45 determines the positions of the nodes 20 in the order denoted by (1) to (7) in FIG. 6.

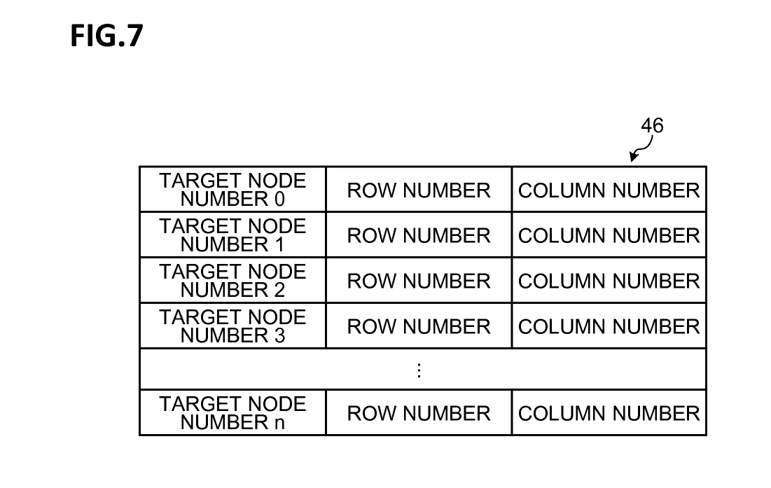

The node map 46 stores the position of each node 20 in the case 1. FIG. 7 is a diagram a illustrating an example of a node map, according to an embodiment. As illustrated in FIG. 7, the node map 46 stores a row number and a column number for each node 20. The row number indicates a number identifying a node row, which corresponds to one of a plurality of stages arranged within the case 1, and the column number indicates a number identifying a node column, which corresponds a column of nodes 20 that are arranged at the same position in node rows of the plurality of stages within the case 1.

The routing table preparing unit 47 uses the node map 46 to prepare a routing table 48 of each node 20, and transmits information of the prepared routing table 48 to each node 20. For example, the routing table preparing unit 47 prepares the routing table 48 in such a manner that data of the source node 20 is first transmitted to a node 20 that is positioned in the same node row as the source node 20 and in the same node column as the destination node 20, and then the data is transmitted from the node 20 to the destination node 20.

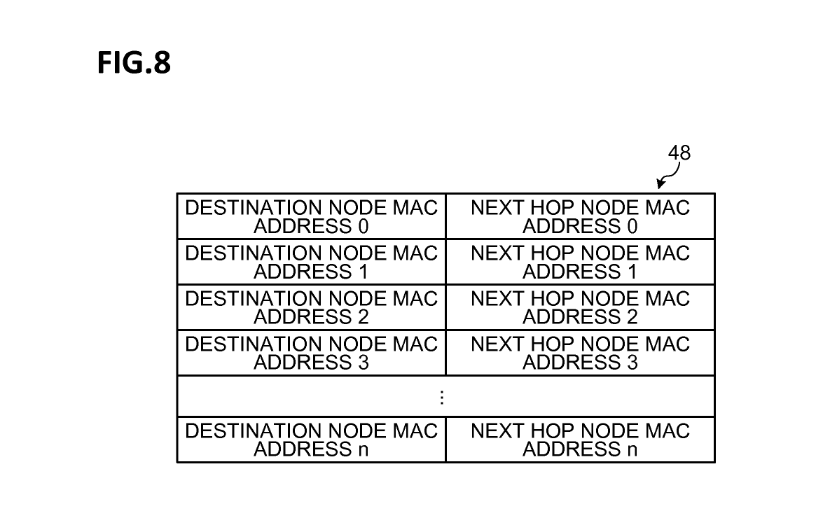

The routing table 48 is a table associating the destination node 20 with the next hop node. FIG. 8 is a diagram illustrating an example of a routing table, according to an embodiment. As illustrated in FIG. 8, the routing table 48 stores a MAC address of the destination node 20 and a MAC address of the next hop node in association with each other.

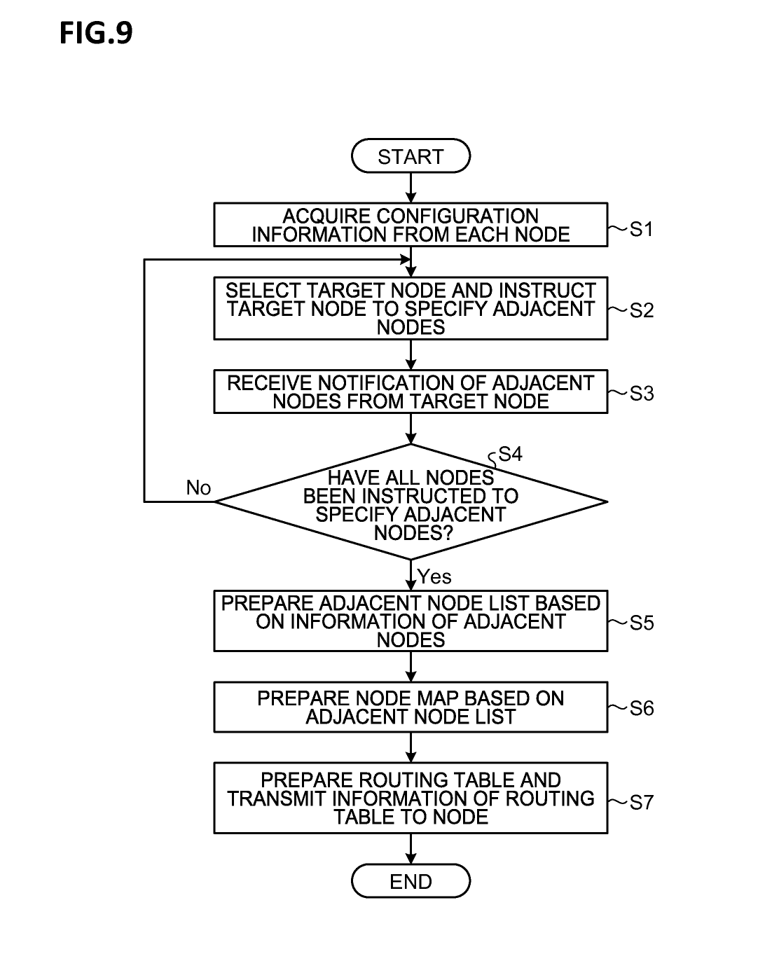

Next, the flow of preparing process of the routing table 48 by the overall control part 40 will be described. FIG. 9 is a diagram illustrating an example of an operational flowchart for preparing a routing table, according to an embodiment.

As illustrated in FIG. 9, the overall controller 40 acquires configuration information from each node 20 (Step S1). Then, the overall controller 40 selects a target node 20 and instructs the target node 20 to specify an adjacent node 20 (Step S2).

Then, the overall controller 40 receives a notification of the adjacent node 20 from the target node 20 (Step S3) and determines whether all the nodes 20 have been instructed to specify the adjacent node 20 (Step S4). As a result, when it is determined that there exists a node which has not been instructed to specify the adjacent node 20, the overall controller 40 returns to Step S2 where a next target node 20 is selected.

On the other hand, when it is determined that all the nodes 20 have been instructed to specify the adjacent node 20, the overall controller 40 prepares the adjacent node list 44 based on information of the adjacent node 20 notified from each node 20 (Step S5).

Then, the overall controller 40 prepares the node map 46 based on the adjacent node list 44 (Step S6). Then, the overall controller 40 prepares the routing table 48 of each node 20 based on the node map 46, and transmits information of the routing table 48 of each node 20 to the each node 20 (Step S7).

In this manner, the overall controller 40 can automatically generate the routing table 48 by preparing the node map 46 based on the adjacent node list 44.

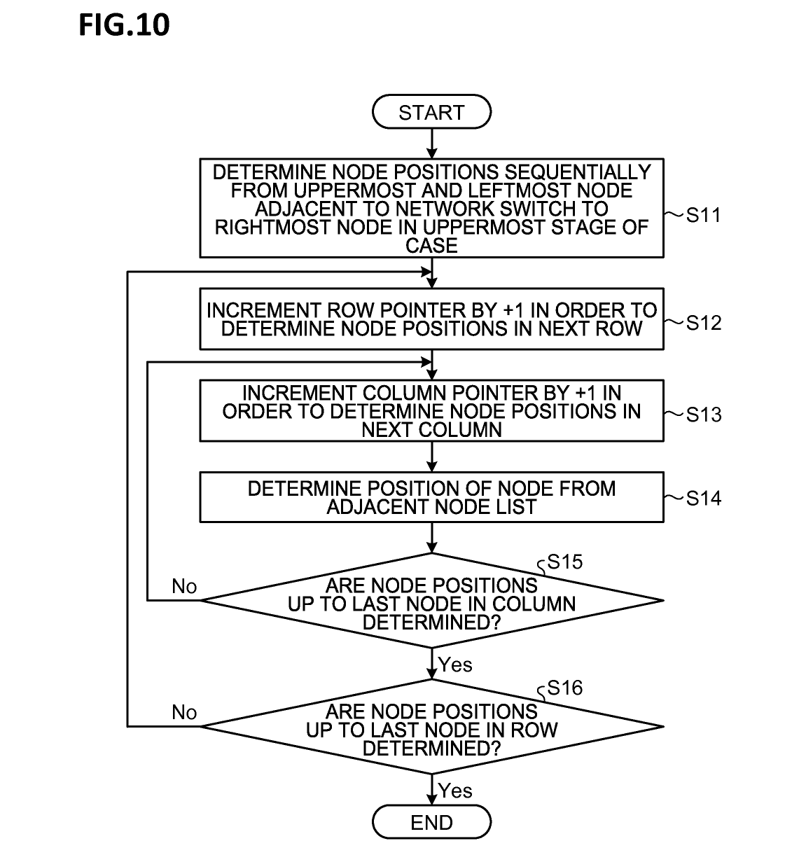

Next, a flow of preparing process of the node map 46 by the node map preparing unit 45 will be described. FIG. 10 is a diagram illustrating an example of an operational flowchart for preparing a node map, according to an embodiment.

As illustrated in FIG. 10, the node map preparing unit 45 determines positions of nodes 20 sequentially from the uppermost and leftmost node 20 adjacent to the network switch 11 to the rightmost node 20 at the uppermost stage of the case 1 (Step S11).

Then, the node map preparing unit 45 increments a row pointer identifying a node row for which positions of nodes 20 are to be determined, by +1 in order to determine positions of nodes 20 in the next node row (Step S12), and increments a column pointer identifying a node column for which positions of nodes 20 are to be determined, by +1 in order to determine positions of nodes 20 in the next node column (Step S13). Then, the node map preparing unit 45 determines the position of a node 20 identified by the row and column pointers, from the adjacent node list 44 (Step S14).

Then, the node map preparing unit 45 determines whether the positions up to the last node 20 in the node column have been determined (Step S15). When it is determined that the positions up to the last node 20 have not been determined, the node map preparing unit 45 returns to Step S13. On the other hand, when it is determined that the positions up to the last node 20 have been determined, the node map preparing unit 45 determines whether positions up to the last node 20 in the node row have been determined (Step S16).

As a result, when it is determined that the position up the last node 20 in the node row has not been determined, the node map preparing unit 45 returns to Step S12. Otherwise, when the positions up to the last node 20 in the node row have been determined, the process ends.

In this manner, the node map preparing unit 45 may determine the positions of all the nodes 20 by repeating the process of determining the positions of nodes from the leftmost node 20 to the rightmost node 20 of a node row, from the uppermost stage to the lowermost stage of the case 1.

As described above, in this embodiment, the information processing system 10 includes a plurality of nodes 20 and the network switch 11 for communication with an external network. In addition, the network switch 11 includes the overall controller 40 for controlling the nodes 20 and the network switch 11, and the overall controller 40 includes the adjacent node list preparing unit 43 and the node map preparing unit 45. The adjacent node list preparing unit 43 prepares the adjacent node list 44 and the node map preparing unit 45 prepares the node map 46 based on the adjacent node list 44. As a result, the information processing system is able to correctly estimate the position of each node 10 in the case 1.

In the above embodiment, it has been illustrated for a case where the position of each node 20 is determined from top to bottom and from left to right in the case 1. However, when a failure occurs in the node 20 or there is an empty space in the case 1, the position of each node 20 may not be determined from top to bottom and from left to right in the case 1. To avoid this problem, another method of using the adjacent node list 44 to determine the position of each node 20 is provided as described below.

When a failure occurs in a node 20 or there is an empty space of nodes 20, since no response is returned from a position having a failure/empty space, a special node number indicating that no response is returned is input in an area in the adjacent node list 44, which is for storing a node number and corresponds to the direction where no response is returned.

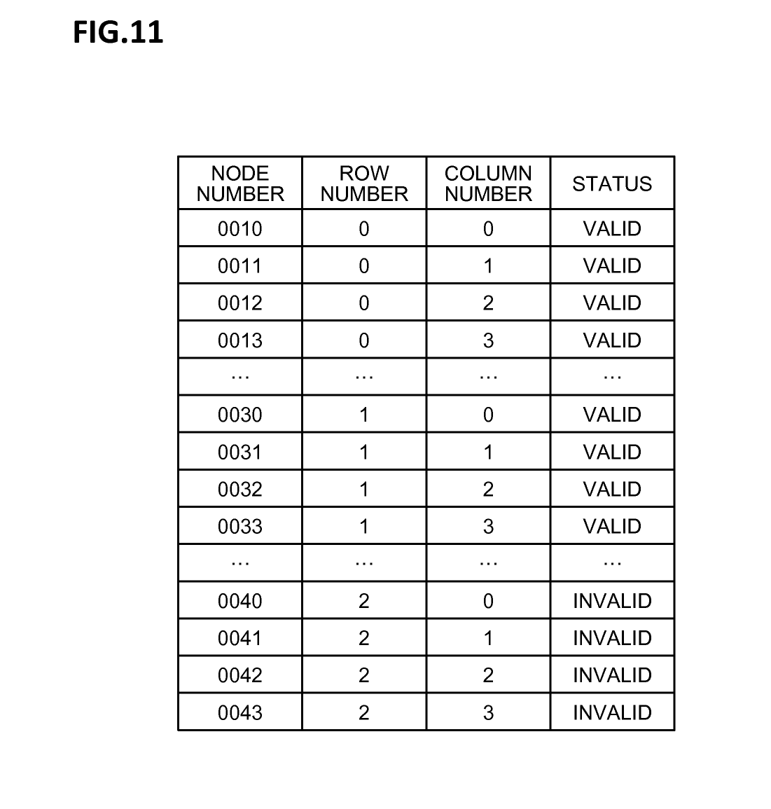

First, the node map preparing unit 45 initializes a specified node list for listing nodes 20 having specified positions. FIG. 11 is a diagram illustrating an example of a specified node list, according to an embodiment. As illustrated in FIG. 11, the specified node list stores a node number, a row number, a column number, and a status for each node 20.

The node number is an identification number for identifying a node 20 and the row and column numbers identify a node row and a node column of the node 20, respectively. The status indicates whether or not the position of the node 20 is specified. The value of the status is “valid” when the position of the node 20 is specified. This value is “invalid” when the position of the node 20 is not specified. The node map preparing unit 45 initializes the row and column numbers at “0” and initializes the status at “invalid”.

Then, the node map preparing unit 45 specifies each node 20 having a number identifying each radio antenna 11b for short-range wireless communication as the upper node number, as the uppermost node 20. Then, the node map preparing unit 45 writes values in row and column numbers corresponding to a node number of a node 20 having a specified position in entries of the specified node list. In addition, the node map preparing unit 45 writes “valid” in a status corresponding to the node number of the specified node 20.

Then, the node map preparing unit 45 selects a node 20 having an unspecified row and column numbers from the specified nod list, and searches node numbers in the vertical and horizontal directions for all target node numbers of the adjacent node list 44, for a node number of the selected node 20.

Then, when the node number of the selected node 20 is searched from the node numbers in the vertical and horizontal directions of the adjacent node list 44, the node map preparing unit 45 specifies the position of the selected node 20 from already specified positions of nodes 20 among adjacent nodes 20.

Then, the node map preparing unit 45 selects a node 20 having an unspecified row and column numbers from the specified node list until a node 20 whose position is to be newly specified is not present, and repeats the same process for the selected node 20.

In this manner, the specified node list and the adjacent node list 44 may be used to specify a node 20 that is adjacent to the node 20 having the specified position in one of the vertical and horizontal directions. FIG. 11 shows that the positions of nodes 20 having node numbers “0010” to “0033” are specified and the positions of nodes 20 having node numbers “0040” to “0043” are not specified.

When a new node is added to an empty slot of the case 1, the overall controller 40 adds a node number of the new node to the adjacent node list 44 and the node map 46. Then, the overall controller 40 instructs, via the management radio, the new node to issue a probe request using the short-range radio. The new node waits for a probe response from adjacent nodes and notifies the overall controller 40 of the probe response via the management radio.

Then, the overall controller 40 prepares a new adjacent node list containing the new node. Since the positions of nodes adjacent to the new node are already estimated, the overall controller 40 may estimate the position of the new node. The overall controller 40 adds the position of the new node to the node map 46.

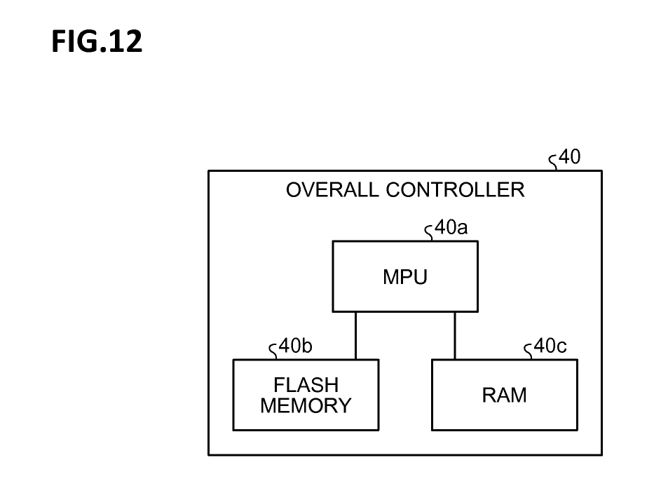

The functionality of the overall controller 40 is implemented by firmware. A hardware configuration of the overall controller 40 implemented by firmware will be described below. FIG. 12 is a diagram illustrating an example of a hardware configuration of an overall controller, according to an embodiment. As illustrated in FIG. 12, the overall controller 40 includes an MPU 40a, a flash memory 40b, and a RAM 40c.

The MPU 40a is an arithmetic processing unit for reading and executing a program from the flash memory 40b. The flash memory 40b is a nonvolatile memory for storing programs. The RAM 40c is a memory for storing an intermediate result and the like of programs.

In addition, although it has been illustrated in the above embodiment for a case where the network switch 11 has 8 (eight) radio antennas 11b for short-range wireless communication, the present disclosure is not limited thereto. For example, the present disclosure may be equally applied to a case where the network switch 11 includes one radio antenna 11b for short-range wireless communication that communicates with only the node 20 arranged at the origin. Further, the present disclosure may be equally applied to a case where the network switch 11 includes four radio antennas 11b for short-range wireless communication that communicate with only nodes 20 positioned in odd-numbered node columns.

In addition, although it has been illustrated in the above embodiment for a case where each node 20 has the short-range radio communication radio antennas 20a to 20d for short-range wireless communication for wirelessly communicating with nodes adjacent thereto in the vertical and horizontal directions, the present disclosure is not limited thereto. For example, the present disclosure may be equally applied to a case where each node has 8 radio antennas for short-range wireless communication for wirelessly communicating with nodes adjacent thereto in the upper, lower, left, right, left-upper, right-upper, left-lower and right-lower directions.

In addition, although it has been illustrated in the above embodiment for a case where the nodes 20 are arranged in the two dimensions, the present disclosure is not limited thereto but may be equally applied to a case where the nodes 20 are arranged in three dimensions.

In addition, although it has been illustrated in the above embodiment for a case where the overall controller 40 is contained in the network switch 11, the present disclosure is not limited thereto but may be equally applied to a case where the overall controller is arranged at different places such as the case 1.

In addition, although it has been illustrated in the above embodiment for a case where node numbers are generated from the MAC addresses, the present disclosure is not limited thereto but may be equally applied to a case where node numbers are generated from different information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a plurality of information processing apparatuses;
a case including a plurality of stages each configured to accommodate information processing apparatuses in a row; and
a controller configured to:
specify, for each of the plurality of information processing apparatuses, a first fixed antenna among fixed antennas fixed to predetermined positions within the case or adjacent information processing apparatuses adjacent to the each information processing apparatus by causing the each information processing apparatus to conduct a wireless communication using the fixed antennas or antennas provided for the adjacent information processing apparatuses, and
estimate a position of the each information processing apparatus within the case, based on the specified adjacent information apparatuses or the specified first fixed antenna.

2. The information processing system of claim 1, wherein
an E-band is used as a radio frequency band for causing the each information processing apparatus to conduct the wireless communication.

3. The information processing system of claim 1, wherein
the fixed antennas are arranged close to an upper side of the plurality of information processing apparatuses within the case; and
the controller estimates positions of the plurality of information processing apparatuses within the case by:
estimating positions of information processing apparatuses that are arranged in an uppermost stage within the case and adjacent to the fixed antennas, and
repeating a position-estimation process, for each of the plurality of stages other than the uppermost stage, downward from a stage next to the uppermost stage to a lowermost stage within the case, the position-estimation process including estimating positions of information processing apparatuses accommodated by the each stage, rightward from leftmost to rightmost information processing apparatuses within the each stage.

4. The information processing system of claim 1, wherein
the controller estimates positions of the plurality of information processing apparatuses within the case by:
estimating positions of information processing apparatuses adjacent to the fixed antennas, and
repeating a position-estimation process of estimating information processing apparatuses adjacent to the information processing apparatus whose position has been estimated until there is no information processing apparatus whose position is to be newly estimated left in the plurality of information processing apparatuses.

5. The information processing system of claim 1, wherein
the case is provided with a switch used for connection of each information processing apparatus to an external network, and
the fixed antennas are included in the switch.

6. A method performed in a system including a plurality of information processing apparatuses and a case including a plurality of stages each configured to accommodate information processing apparatuses in a row, the method comprising:
specifying, for each of the plurality of information processing apparatuses, a first fixed antenna among fixed antennas fixed to predetermined positions within the case or adjacent information processing apparatuses adjacent to the each information processing apparatus by causing the each information processing apparatus to conduct a wireless communication using the fixed antennas or antennas provided for the adjacent information processing apparatuses, and
estimating a position of the each information processing apparatus within the case, based on the specified adjacent information apparatuses or the specified first fixed antenna.

7. A non-transitory, computer-readable recording medium having stored therein a program for a computer included in a system to perform a process, the system including a plurality of information processing apparatuses and a case including a plurality of stages each configured to accommodate information processing apparatuses, the process comprising:
specifying, for each of the plurality of information processing apparatuses, a first fixed antenna among fixed antennas fixed to predetermined positions within the case or adjacent information processing apparatuses adjacent to the each information processing apparatus by causing the each information processing apparatus to conduct a wireless communication using the fixed antennas or antennas provided for the adjacent information processing apparatuses, and
estimating a position of the each information processing apparatus within the case, based on the specified adjacent information apparatuses or the specified first fixed antenna.
